(19) United States
(12) Patent Application Publication
(10) Pub. No.: US 2025/0328300 A1
(43) Pub. Date: Oct. 23, 2025

(54) IMAGE PROCESSING APPARATUS AND IMAGE PROCESSING METHOD

(71) Applicant: CANON KABUSHIKI KAISHA, Tokyo (JP)

(72) Inventor: ISSEI OKADA, Kanagawa (JP)

(21) Appl. No.: 19/173,088

(22) Filed: Apr. 8, 2025

(30) Foreign Application Priority Data
Apr. 17, 2024 (JP) 2024-066823

(51) Int. Cl. G06F 3/14; G06T 7/20; G06V 10/60; G06V 40/16

(52) U.S. Cl. CPC G06F 3/14; G06T 7/20; G06V 10/60; G06V 40/176

(57) ABSTRACT

Disclosed is an image processing apparatus selects one of a plurality of moving image data pieces in a predetermined order and outputs the selected moving image data piece to an outside, wherein the plurality of moving image data pieces are obtained by a plurality of image capture apparatuses set at locations that are geographically different from one another. The image processing apparatus dynamically changes a length of a period in which the selected moving image data piece is output to the outside, based on one or more of temporal changes in the plurality of moving image data pieces and temporal changes in information related to viewing of the moving image data piece currently selected.

### BACKGROUND OF THE INVENTION

### Field of the Invention

The present invention relates to an image processing apparatus and an image processing method, and especially to a technique to switch among a plurality of videos.

### Description of the Related Art

It is proposed in Japanese Patent Laid-Open No. 2018-56930 that, on a mobile terminal including a front camera and a rear camera, from which camera a video is to be externally transmitted is automatically switched depending on whether the mobile terminal is in a vertical orientation or a horizontal orientation.

Japanese Patent Laid-Open No. 2018-56930 deals with a plurality of cameras provided on the same device. Therefore, it is not applicable to switching among videos obtained by a plurality of image capture apparatuses set at locations that are geographically different from one another.

### SUMMARY OF THE INVENTION

One aspect of the present invention provides an image processing apparatus and an image processing method capable of appropriately switching among moving image data pieces obtained by a plurality of image capture apparatuses set at locations that are geographically different from one another.

According to an aspect of the present invention, there is provided an image processing apparatus comprising: one or more processors that execute a program stored in a memory, and thereby cause the image processing apparatus to select one of a plurality of moving image data pieces in a predetermined order and output the selected moving image data piece to an outside, wherein the plurality of moving image data pieces being obtained by a plurality of image capture apparatuses set at locations that are geographically different from one another, wherein the one or more processors cause the image processing apparatus to dynamically change a length of a period in which the selected moving image data piece is output to the outside, based on one or more of temporal changes in the plurality of moving image data pieces and temporal changes in information related to viewing of the moving image data piece currently selected.

According to another aspect of the present invention, there is provided an image processing method comprising: selecting one of a plurality of moving image data pieces in a predetermined order and outputs the selected moving image data piece to an outside, wherein the plurality of moving image data pieces being obtained by a plurality of image capture apparatuses set at locations that are geographically different from one another; based on one or more of temporal changes in the plurality of moving image data pieces and temporal changes in information related to viewing of the moving image data piece currently selected, dynamically changing a length of a period in which the selected moving image data piece is output to the outside.

According to a further aspect of the present invention, there is provided a non-transitory computer-readable medium storing a program for causing a computer to function as an image processing apparatus that selects one of a plurality of moving image data pieces in a predetermined order and outputs the selected moving image data piece to an outside, wherein the plurality of moving image data pieces being obtained by a plurality of image capture apparatuses set at locations that are geographically different from one another, wherein the image processing apparatus dynamically changes a length of a period in which the selected moving image data piece is output to the outside, based on one or more of temporal changes in the plurality of moving image data pieces and temporal changes in information related to viewing of the moving image data piece currently selected.

Further features of the present invention will become apparent from the following description of exemplary embodiments (with reference to the attached drawings).

### BRIEF DESCRIPTION OF THE DRAWINGS

FIG. 1 is a schematic diagram of a distribution system according to an embodiment.

FIG. 2 is a block diagram showing an exemplary functional configuration of an image processing apparatus according to an embodiment.

FIG. 3 is a block diagram showing an exemplary functional configuration of an image capture apparatus usable in an embodiment.

FIG. 4 is a schematic diagram of data processing applied by the image processing apparatus according to an embodiment.

FIG. 5 is a diagram showing an example of source rotation according to an embodiment.

FIG. 6 is a diagram for describing an operation of the image processing apparatus according to an embodiment.

FIG. 7 is a diagram for describing an operation of a timer computation unit according to an embodiment.

FIG. 8 is a diagram for describing an operation of controlling source rotation according to an embodiment.

FIG. 9 is a flowchart related to operations of the image processing apparatus according to an embodiment.

FIG. 10 is a flowchart related to operations of the image processing apparatus according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Note that the following describes a mode in which the present invention is implemented on a personal computer, which is one example of an image processing apparatus. However, the present invention can be implemented on any electronic devices that include one or more computation circuits or processors configured to be capable of executing a program. Typical examples of such electronic devices include, but are not limited to, a tablet device and a smartphone.

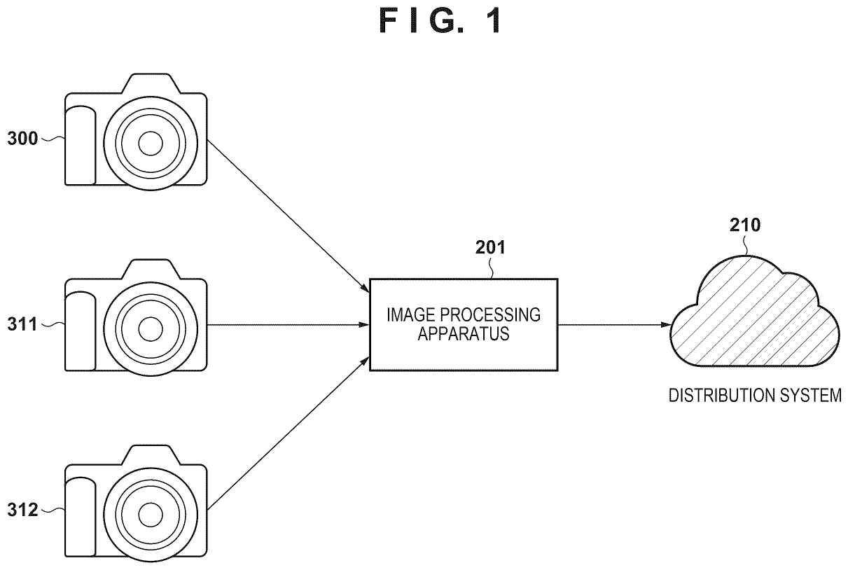

FIG. 1 is a schematic diagram showing an example of an environment in which an image processing apparatus according to an embodiment is used. A plurality of cameras 300, 311, and 312 are connected to an image processing apparatus 201 wirelessly or by wire. Wireless connection may be direct connection, such as P2P, or may be indirect connection via a network. Below, the plurality of cameras 300, 311, and 312 may be collectively referred to as a plurality of cameras 300.

The cameras 300, 311, and 312 are installed at geographically different locations. The cameras 300, 311, and 312 may have the same shooting range or different shooting ranges. For example, the angles of view may be set so that a part or all of the cameras 300, 311, and 312 shoot the same shooting range from different viewpoints. Also, at least one of the shooting directions and the angles of view of the cameras 300, 311, and 312 may be remotely controllable.

Furthermore, the cameras 300, 311, and 312 are set to continuously shoot moving images, and immediately output data pieces of the shot moving images to the image processing apparatus 201. The moving image data pieces output from the cameras 300, 311, and 312 may include sound analysis data, subtitle data, and the like in addition to image data and sound data.

The image processing apparatus 201 selects moving image data to be output to a distribution system 210 from among the moving image data pieces received from the cameras 300, 311, and 312. The image processing apparatus 201 may apply image processing and convert a data format before outputting the selected moving image data to the distribution system 210. A method in which the image processing apparatus 201 selects the moving image data to be output will be described later.

The distribution system 210 distributes the moving image data output from the image processing apparatus 201 to a plurality of viewers. As a configuration and a distribution method of the distribution system 210 are not directly related to the present invention, a description related to the details thereof is omitted.

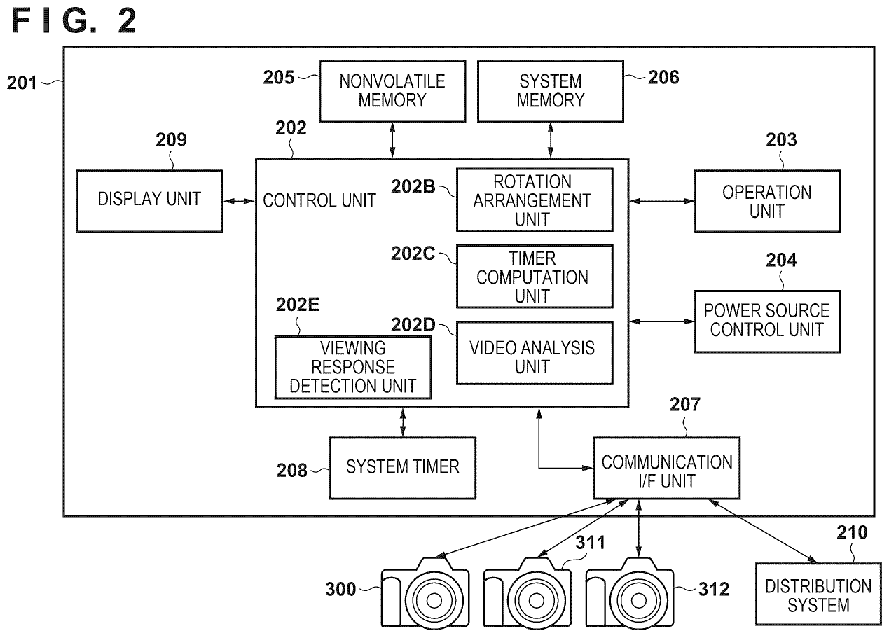

FIG. 2 is a block diagram showing an exemplary functional configuration of the image processing apparatus 201. A nonvolatile memory 205 may be electrically erasable and recordable. A program executed by a control unit 202, various types of setting values, and the like are stored in the nonvolatile memory 205. The operations of the image processing apparatus 201, which will be described later using a flowchart, are realized by the control unit 202 reading the program stored in the nonvolatile memory 205 to a system memory 206 and executing the program. Furthermore, the nonvolatile memory 205 can also store data, such as moving image data pieces received from the cameras 300, 311, and 312.

The control unit 202 includes at least one computation circuit or processor. The control unit 202 realizes the operations of the image processing apparatus 201 by reading the program stored in the nonvolatile memory 205 to the system memory 206 and executing the program.

In the figure, functional blocks 202A to 202E shown inside the control unit 202 are schematic representations of typical functions that are realized by the control unit 202 executing the program. Therefore, the operations that are executed by the functional blocks 202A to 202E inside the control unit 202 in the following description are, in practice, executed by the control unit 202.

Note that one or more of the functions that are realized by the control unit 202 executing the program may be implemented by a hardware circuit (an ASIC, an FPGA, or the like) different from the control unit 202, or by using the hardware circuit.

The system memory 206 is a volatile memory, such as a RAM. The system memory 206 is used to temporarily store the program executed by the control unit 202, variables and constants necessary for the execution of the program, intermediate data, and the like. The system memory 206 is also used as a buffer memory for moving image data and the like, and a video memory of a display unit 209.

Under control of the control unit 202, a system timer 208 obtains the time of a built-in clock of the image processing apparatus 201, and measures a period that has been set.

An operation unit 203 is a general term for user-operable input devices provided in the image processing apparatus 201. The operation unit 203 can include a power source button for switching between ON and OFF of the image processing apparatus 201, and input devices (e.g., a keyboard, a mouse, and a touch panel) for operating a user interface provided by the program.

A power source control unit 204 supplies power of an appropriate form and voltage to each component of the image processing apparatus 201 from a power source, such as a commercial power source, an AC adapter, and a battery.

The display unit 209 is, for example, a liquid crystal display. The display unit 209 displays a user interface provided by the program executed by the control unit 202, moving image data, text data, and the like. The display unit 209 may be a touch display; in this case, the display unit 209 also functions as the operation unit 203. The display unit 209 may be an apparatus external to the image processing apparatus 201.

A communication I/F unit 207 enables the image processing apparatus 201 to communicate with external devices. The communication I/F unit 207 supports one or more of known wired and wireless communication protocols, and includes a circuit appropriate for the supported communication protocol(s), as well as an antenna and/or a connector. In the present embodiment, the image processing apparatus 201 communicates with the cameras 300, 311, and 312 and the distribution system 210 via the communication I/F unit 207.

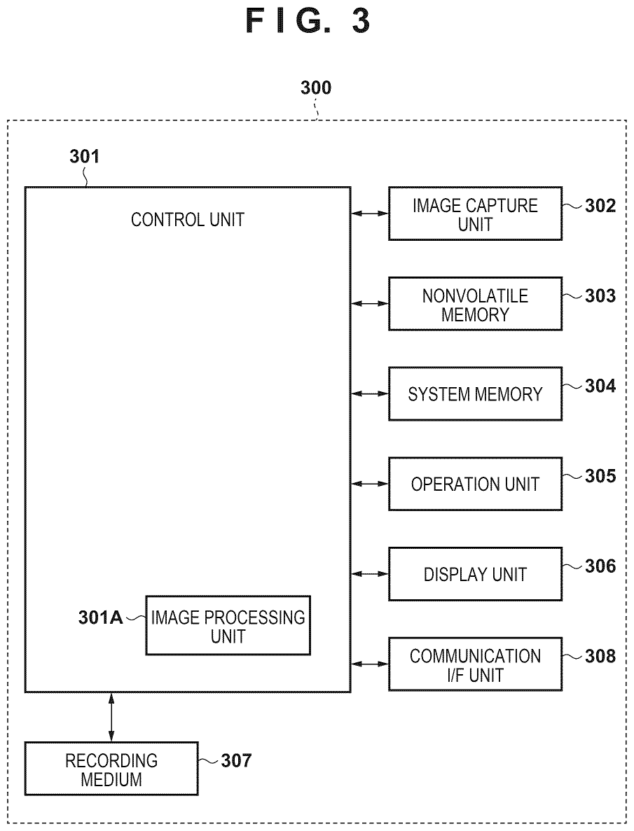

FIG. 3 is a block diagram showing an exemplary functional configuration of the camera 300. Note that although the exemplary functional configuration of the camera 300 will be described as a representative below, it is assumed that the cameras 311 and 312 also have a similar functional configuration. Note that one or more of the cameras 300, 311, and 312 are not limited to digital cameras, and may be any electronic devices capable of shooting moving images in parallel with outputting of shot moving image data to the outside. Typical examples of such electronic devices include, but are not limited to, a tablet device and a smartphone.

A control unit 301 includes at least one computation circuit or processor. The control unit 301 realizes the operations of the camera 300 by reading a program stored in a nonvolatile memory 303 to a system memory 304 and executing the program. Also, an image processing unit 301A shown inside the control unit 301 is a schematic representation of a function that is realized by the control unit 301 executing the program. Therefore, the operations that are executed by the image processing unit 301A in the following description are, in practice, executed by the control unit 301.

Note that one or more of the functions that are realized by the control unit 301 executing the program may be implemented by a hardware circuit (an ASIC, an FPGA, or the like) different from the control unit 301, or by using the hardware circuit.

An image capture unit 302 includes an image sensor and a lens (an optical system) that generates an optical image of a subject on the image sensor. The image sensor may be, for example, a known CCD or CMOS color image sensor that includes color filters based on the primary-color Bayer array. The image sensor includes a pixel array in which a plurality of pixels are arrayed two-dimensionally, and peripheral circuits for reading out a signal from each pixel. Through photoelectric conversion, each pixel accumulates charges corresponding to the amount of incident light. A signal with a voltage corresponding to the amount of charges accumulated during an exposure period is read out from each pixel; as a result, a pixel signal group (analog image signals) representing a subject image created by the lens is obtained.

The analog image signals output from the image capture unit 302 are supplied to the image processing unit 301A. The image processing unit 301A applies predetermined image processing to the analog image signals, thereby generating evaluation values and image data that suit the intended use.

The image processing applied by the image processing unit 301A can include, for example, preprocessing, color interpolation processing, correction processing, detection processing, data editing processing, evaluation value calculation processing, special effects processing, and so forth.

The preprocessing can include A/D conversion, signal amplification, reference level adjustment, defective pixel correction, and so forth.

The color interpolation processing is processing which is executed in a case where the image sensor is provided with color filters, and which interpolates values of color components that are not included in the individual pixel data pieces composing image data. The color interpolation processing is also called demosaicing processing.

The correction processing can include such processing as white balance adjustment, tone correction, correction of image degradation caused by optical aberration of the lens (image recovery), correction of the influence of vignetting of the lens, and color correction.

The detection processing can include detection of a characteristic area (e.g., a face area or a human body area) and a motion therein, processing for recognition of a person, and so forth.

The data editing processing can include such processing as cutout of an area (cropping), composition, scaling, encoding and decoding, and generation of header information (generation of a data file). The data editing processing also includes generation of image data for display and image data for recording.

The evaluation value calculation processing can include such processing as generation of signals and evaluation values used in automatic focus detection (AF), and generation of evaluation values used in automatic exposure control (AE).

The special effects processing can include such processing as addition of blur effects, alteration of shades of colors, relighting, and so forth.

Note that these are examples of processing that can be applied by the image processing unit 301A, and do not limit processing applied by the image processing unit 301A.

Note that during shooting of moving images, the image capture unit 302 continues to shoot at a predetermined frame rate. Then, the image processing unit 301A generates moving image data by using image signals obtained from the image capture unit 302 and sound signals obtained from a non-illustrated microphone. The image processing unit 301A records the generated moving image data to a recording medium 307, and outputs the generated moving image data to an external apparatus, such as the image processing apparatus 201, via a communication I/F unit 308.

The nonvolatile memory 303 is an electrically erasable and recordable nonvolatile memory, and stores the program executed by the control unit 301, various types of setting values of the camera 300, and the like.

The system memory 304 is a volatile memory, such as a RAM. The system memory 304 is used to temporarily store the program executed by the control unit 301, variables and constants necessary for the execution of the program, intermediate data, and the like. The system memory 304 is also used as a buffer memory for moving image data and the like, and a video memory of a display unit 306.

An operation unit 305 is a general term for input devices (buttons, switches, dials, and the like) provided for the user to input various types of instructions to the camera 300. The input devices composing the operation unit 305 have names corresponding to the functions assigned thereto. For example, the operation unit 305 includes a release switch, a moving image recording switch, a shooting mode selection dial for selecting a shooting mode, a menu button, direction keys, a determination key, and so forth. The release switch is a switch for recording a still image; the control unit 301 recognizes a state where the release switch is pressed halfway down as a shooting preparation instruction, and a state where the release switch is fully pressed down as a shooting start instruction. Also, the control unit 301 recognizes depression of the moving image recording switch in a shooting standby state as an instruction for starting recording of moving images, and recognizes depression of the moving image recording switch during recording of moving images as an instruction for stopping recording. Note that the functions assigned to the same input device may be variable. Also, the input devices may be software buttons or keys that use a touch display. Furthermore, the operation unit 305 may include input devices that support contactless input methods, such as voice input and line-of-sight input.

Upon recognition of a shooting preparation instruction, the control unit 301 starts shooting preparation processing for a still image, such as autofocus (AF) processing and automatic exposure (AE) processing. Also, upon recognition of a shooting start instruction, the control unit 301 executes a processing sequence from shooting of a still image and recording of the same.

The display unit 306 is, for example, a display mounted on a surface of a housing of the camera 300. It is possible to cause the display unit 306 to function as an electronic viewfinder (EVF) by continuously executing shooting of moving images and display of generated moving image data for display on the display unit 306. Moving image data that is used to cause the display unit 306 to function as the EVF is called live-view images. The display unit 306 is also used to display image data recorded in the recording medium 307, information on the camera 300, a menu screen, and the like. The display unit 306 may be an external apparatus.

The communication I/F unit 308 enables the camera 300 to communicate with external apparatuses. The communication I/F unit 308 supports one or more of known wired and wireless communication protocols, and includes a circuit appropriate for the supported communication protocol(s), as well as an antenna and/or a connector. In the present embodiment, the camera 300 communicates with the image processing apparatus 201 via the communication I/F unit 308.

Below, it is assumed that the communication I/F unit 207 of the image processing apparatus 201 and the communication I/F unit 308 of the camera 300 support the same wireless LAN protocol and perform communication in accordance with the wireless LAN protocol. However, other known communication protocols, such as a USB and Bluetooth®, may be used.

Image data generated based on image capture that uses the image capture unit 302 is recorded in the recording medium 307. The recording medium 307 may be, for example, an attachable/removable memory card, but also may be, for example, an unattachable/unremovable nonvolatile memory or hard disk drive.

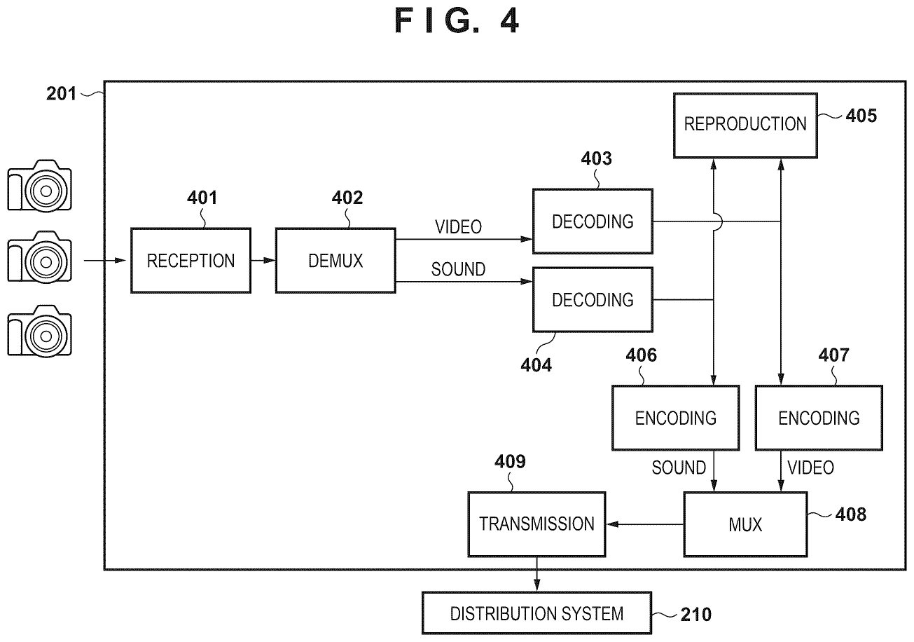

FIG. 4 is a diagram schematically showing a flow of processing that is executed by the image processing apparatus 201 with respect to data received from the camera 300. Processing indicated by blocks in FIG. 4 is executed by the control unit 202 reading the program stored in the nonvolatile memory 205 to the system memory 206 and executing the program.

Note, it is assumed here that moving image data pieces output from the cameras 300, 311, and 312 are in a state where they can be distributed live via the distribution system 210. That is to say, it is assumed that the cameras 300, 311, and 312 are currently shooting moving images, and generated moving image data pieces are supplied to the image processing apparatus 201.

The image processing apparatus 201 selects one stream of moving image data from among three streams of moving image data received from the cameras 300, 311, and 312, and outputs the same to the distribution system 210. Note that, for the sake of convenience, a description of processing for selecting (switching) moving image data to be output to the distribution system 210 is not provided here. Only processing applied between the reception and output of one stream of moving image data to be output to the distribution system 210 will be described.

In reception processing 401, the control unit 202 receives moving image data from the cameras 300, 311, and 312 via the communication I/F unit 207. The control unit 202 stores the received moving image data to the system memory 206. The moving image data received in the reception processing 401 can be in a format corresponding to the specifications of the cameras 300, 311, and 312, for example, a format conforming to a known streaming protocol, such as RTMP, RTSP, HLS, and MPEG-DASH. Then, the control unit 202 extracts data of videos and sounds from the received moving image data. For example, the control unit 202 extracts data in the FLV format from the moving image data in the RTMP format.

Then, through DEMUX processing 402, the control unit 202 separates the extracted data of videos and sounds into data of videos and data of sounds. For example, the control unit 202 separates the data in the FLV format into video data in the H.264 format and sound data in the AAC format.

The control unit 202 applies decode processing to each of the separated video data and sound data. Specifically, the control unit 202 applies decode processing 403 to the video data, and decode processing 404 to the sound data. The purpose of the decode processing 403, 404 is conversion into a data format supported by reproduction processing 405. Therefore, the post-decoding data format can vary depending on the specifications of the reproduction processing 405.

The control unit 202 applies the reproduction processing 405 to the video data and the sound data to which the decode processing 403, 404 has been applied. The reproduction processing 405 may be, for example, processing for display on the display unit 209 with respect to the video data, and processing for output from a speaker with respect to the sound data.

Also, the control unit 202 applies encode processing 407 and encode processing 406 to the video data and the sound data to which the decode processing 403 and the decode processing 404 have been applied, respectively. The purpose of the encode processing 407, 406 is conversion into a data format supported by the distribution system 210. Therefore, the post-encoding data format can vary depending on the specifications of distribution system 210.

The control unit 202 applies multiplex (MUX) processing 408 to the video data and the sound data to which the encode processing 407, 406 has been applied. Whether the multiplex processing 408 is necessary, and which format is to be achieved through multiplexing, can vary depending on the specifications of the distribution system 210.

The control unit 202 applies processing 409 for transmission to the distribution system 210 with use of the communication I/F unit 207 with respect to the moving image data to which the multiplex processing 408 has been applied as necessary.

Note that processing for converting one or more of the resolution, frame rate, data rate, and the like in accordance with, for example, necessity and settings may be applied in at least one of the reproduction processing 405 and the encode processing 406, 407.

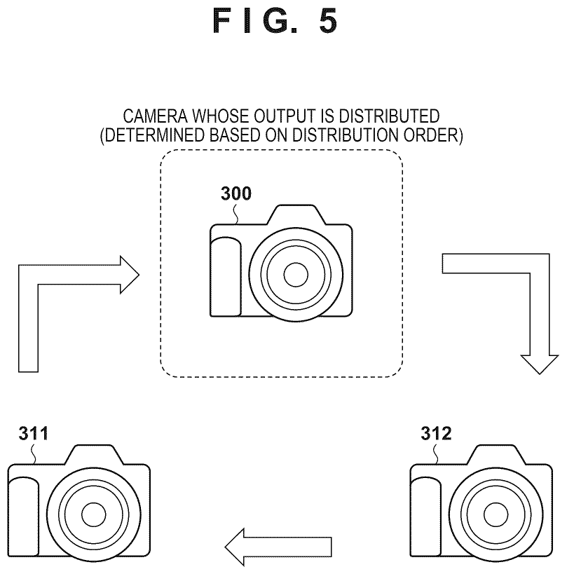

FIG. 5 is a diagram schematically showing source rotation as one example of a method of selecting moving image data to be output to the distribution system 210, which is executed by the image processing apparatus 201. The source rotation is a method in which a selection is made sequentially and repeatedly from among a plurality of streams of input image data. It is assumed that the order of selection is stored in the nonvolatile memory 205 in advance as setting information. Also, the order of selection may be changeable by the user via the operation unit 203. FIG. 5 shows an example in which the source rotation is performed in the following order: moving image data of the camera 300→moving image data of the camera 311→moving image data of the camera 312→moving image data of the camera 300→ . . . .

Note that the order of selection may be dynamically determined using any method. The control unit 202 may, for example, randomly determine moving image data to be selected next, or determine the same on the basis of evaluation values obtained from images. Also, it is possible to allow moving image data pieces from the same camera to be selected in succession, or prohibit such selection. Furthermore, it is possible to prevent moving image data pieces from the same camera from being selected until the selection of moving image data pieces goes full circle.

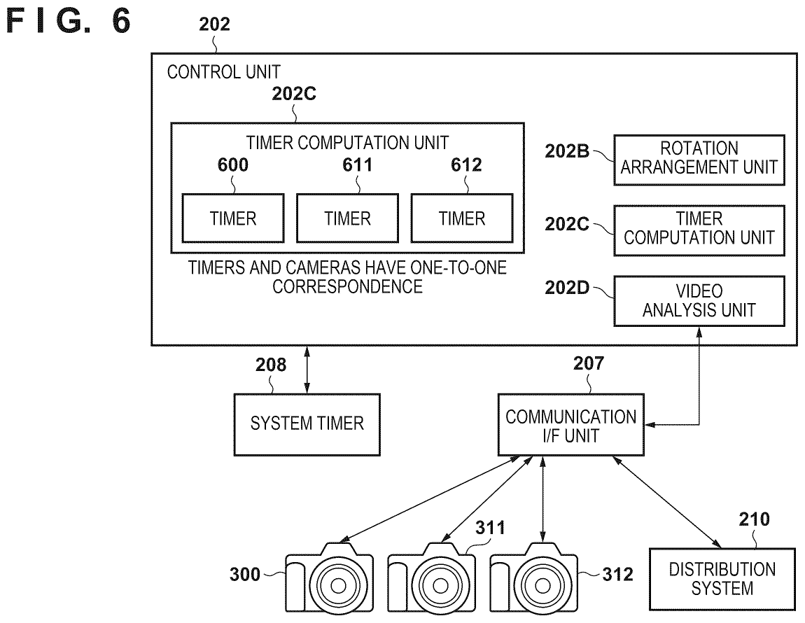

The image processing apparatus 201 dynamically changes the length of a period in which moving image data is selected from each camera. The operation of dynamically changing the length of the period will be described after providing a description of a basic operation of the image processing apparatus 201 (control unit 202) to select moving image data using FIG. 6.

As stated earlier, the functional blocks 202A to 202D inside the control unit 202 are representations of operations executed by the control unit 202 as functional blocks. A timer computation unit 202C includes a plurality of timers that are in one-to-one correspondence with the plurality of cameras that are supply sources of image data pieces. In the example of FIG. 6, the timer computation unit 202C includes a timer 600 corresponding to the camera 300, a timer 611 corresponding to the camera 311, and a timer 612 corresponding to the camera 312. It is assumed that the periods measured by the timers 600, 611, and 612 are the same in an initial state. Note that although the timers 600, 611, and 612 may be in any format, it is assumed here that, as one example, they are countdown timers, and an initial value corresponding to the measured periods has been set.

It is assumed that a camera from which moving image data is selected first is the camera 300. Using one of the aforementioned methods, a rotation arrangement unit 202B determines from which camera moving image data is to be selected next. From which camera moving image data is to be selected next can be specified by referring to the rotation arrangement unit 202B.

The control unit 202 refers to the rotation arrangement unit 202B, and starts to select moving image data of the camera 300 in the reception processing 401. As a result, outputting of moving image data of the camera 300 from the communication I/F unit 207 to the distribution system 210 is started. Also, the control unit 202 starts a time measurement with use of the timer 600 corresponding to the camera 300. The rotation arrangement unit 202B determines from which camera moving image data is to be selected next.

Thereafter, upon detecting that a count value of the timer 600 has reached 0, the control unit 202 refers to the rotation arrangement unit 202B. The control unit 202 starts to select moving image data of the camera 312 in the reception processing 401. As a result, outputting of moving image data of the camera 312 from the communication I/F unit 207 to the distribution system 210 is started. Also, the control unit 202 starts a time measurement with use of the timer 612 corresponding to the camera 312. At this point, the control unit 202 may reset the value of the timer 600 to the initial value.

Upon detecting that a count value of the timer 612 has reached 0, the control unit 202 refers to the rotation arrangement unit 202B. The control unit 202 starts to select moving image data of the camera 311 in the reception processing 401. As a result, outputting of moving image data of the camera 311 from the communication I/F unit 207 to the distribution system 210 is started. Also, the control unit 202 starts a time measurement with use of the timer 611 corresponding to the camera 311. At this point, the control unit 202 may reset the value of the timer 600 to the initial value.

Upon detecting that a count value of the timer 611 has reached 0, the control unit 202 refers to the rotation arrangement unit 202B. The control unit 202 starts to select moving image data of the camera 300 in the reception processing 401. As a result, outputting of moving image data of the camera 300 from the communication I/F unit 207 to the distribution system 210 is started. Also, the control unit 202 starts a time measurement with use of the timer 600 corresponding to the camera 300. At this point, the control unit 202 may reset the value of the timer 612 to the initial value.

Thereafter, if the control unit 202 repeats the processing in a similar manner, moving image data is output to the distribution system 210 every certain period from the three cameras 300, 312, and 311, in this order. The foregoing is the basic operation of selecting moving image data.

Next, a description is given of an operation performed by the control unit 202 (timer computation unit 202C) to dynamically change a period of selection of each individual moving image data. As one example, the following describes an operation of dynamically changing the period of selection of moving image data on the basis of one or more of evaluation values related to a temporal change in moving image data and a temporal change in information on viewing of moving images currently output to the distribution system.

Examples of evaluation values related to a temporal change in moving image data can include one or more of the following.
A motion in entire frames
A moving speed or acceleration of a subject inside the frames
A motion of a subject (a change in an action or a facial expression)
A luminance change in an entirety or a subject region of the frames
A change in a frame rate
A change in the volume or main frequency of sounds

As these evaluation values can be detected using any known method, a description of details of a method of detecting or calculating each individual evaluation value is omitted.

A video analysis unit 202D calculates evaluation values related to a temporal change in moving image data with respect to image data pieces received from one or more of the cameras 300, 311, and 312 via the communication I/F unit 207, and stores them to the system memory 206.

Also, examples of a temporal change in information on moving image data currently output to the distribution system can include one or more of the following.
A change in the number of viewers
A change in the number of comments in an SNS related to moving image data currently distributed
The number of likes and/or dislikes
A change in the total amount of so-called fan funding
A viewing response detection unit 202E obtains information on viewing from the distribution system 210, and stores the information to the system memory 206.

Then, the timer computation unit 202C increases or reduces the periods measured by the timers 600, 611, and 612 on the basis of one or more of evaluation values related to a temporal change in moving image data and a temporal change in information on viewing of moving images currently distributed. In this way, the length of the period of selection (period of distribution) of moving image data pieces from the cameras 300, 311, and 312 is changed.

With regard to both of the evaluation values related to the temporal change in moving image data and the temporal change in information on viewing of moving images currently distributed, the timer computation unit 202C increases the selection period (delays the timing of switchover) if the temporal change is equal to or larger than a first threshold. Also, with regard to both of the evaluation values related to the temporal change in moving image data and the temporal change in information on viewing of moving images currently distributed, the timer computation unit 202C reduces the selection period (advances the timing of switchover) if the temporal change is smaller than a second threshold. The first threshold is equal to or larger than the second threshold. In this way, an adjustment can be automatically made so that the period of selection of moving image data that lacks in variety becomes short, and the period of selection of moving image data full of variety becomes long. Therefore, for example, in a case where a person performs live distribution alone using a plurality of image capture apparatuses, it is possible to automatically switch among moving image data pieces so as not to bore viewers. The amount of increase or the amount of reduction per time may be fixed, or may vary depending on the type of evaluation values as will be described later.

In a case where the timers are countdown timers, the timer computation unit 202C can increase the selection period (delay the timing of switchover) by increasing the count values of the timers. Similarly, the timer computation unit 202C can reduce the selection period (advance the timing of switchover) by reducing the count values of the timers. In a case where the timers are count-up timers, the relationship between the increase/reduction in the count values and the increase/reduction in the selection period is reversed. Note that the increase/reduction in the count values of the timers based on evaluation values, and a count operation of the timers for measuring the selection period, are executed independently of each other.

The control unit 202 changes the length of the period of selection of moving image data currently selected (currently distributed) each time the aforementioned evaluation values are updated. The evaluation values can be calculated every n frames of moving image data (n is an integer equal to or larger than 1), or every certain period. The frequency of calculation of the evaluation values can be determined and stored in the nonvolatile memory 205 in advance.

Furthermore, with respect to unselected moving image data, too, the control unit 202 changes the length of the selection period in parallel on the basis of the aforementioned evaluation values. The frequency of calculation of evaluation values related to unselected moving image data may be lower than the frequency of calculation of evaluation values for moving image data currently selected. Alternatively, the calculation of evaluation values and the adjustment of the selection period may not be performed until the time remaining in the period of selection of moving image data currently selected becomes smaller than a threshold.

Note that an upper limit of the length of the selection period can be set regardless of whether moving image data is currently selected. With regard to moving image data currently selected, the selection period ends at a time point when a period that has elapsed since the start of the selection has reached the upper limit of the length of the selection period, regardless of the count values of the timers. In this way, moving image data to be distributed is switched at least each time the upper limit of the length of the selection period has been reached. With regard to unselected moving image data, the timers are set so that the count values thereof (the initial value) do not exceed a count value corresponding to the upper limit of the length of the selection period. The upper limit of the length of the selection period (a period or a count value) can be stored in the nonvolatile memory 205.

A lower limit value of the length of the selection period is 0. Also, in a case where the count value (initial value) of the timer corresponding to moving image data (camera) to be selected next is equal to or smaller than a predetermined lower limit value larger than 0, the control unit 202 may skip the selection of this moving image data (camera). This can suppress an incidence where a troublesome impression is given to the viewers due to switchover in a short period.

Also, the control unit 202 may place a part of the cameras 300, 311, and 312 in a sleep state. A camera in the sleep state does not supply moving image data. Therefore, the control unit 202 selects moving image data pieces from the cameras that are not in the sleep state in sequence. For example, in a case where the camera 300 is in the sleep state, the control unit 202 alternately selects moving image data pieces from the cameras 311 and 312. The control unit 202 can place the cameras connected to the communication I/F unit 207 in the sleep state or cancel the sleep state by transmitting a command to the cameras by way of communication via the communication I/F unit 207.

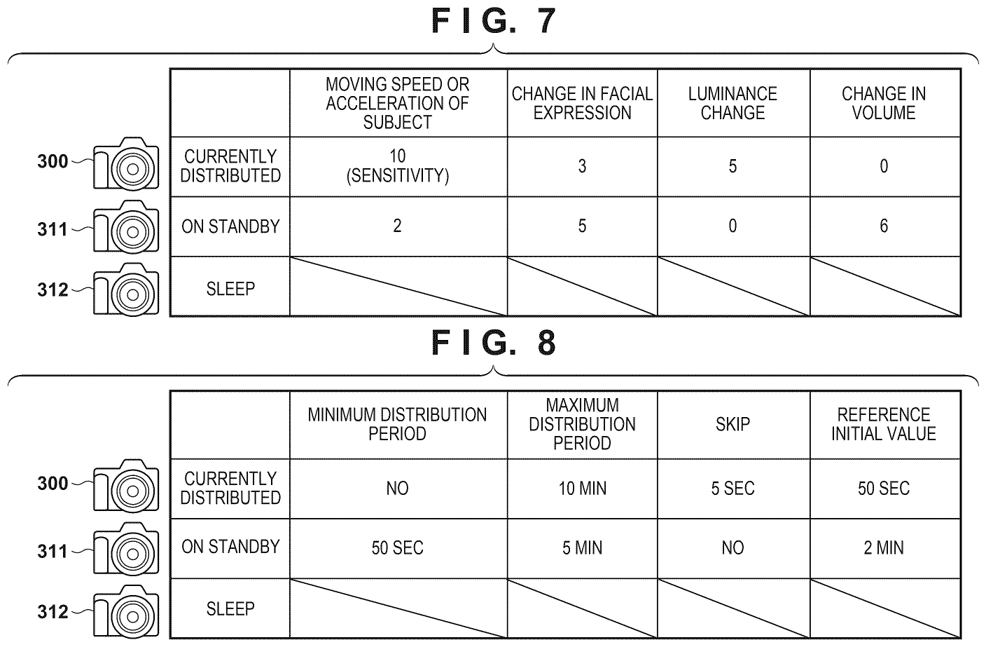

A specific example of the operation of the timer computation unit 202C will be described using FIG. 7. Here, four types of evaluation values among the plurality of evaluation values described above are used in combination. Also, the control unit 202 is currently selecting (currently distributing) moving image data of the camera 300. Moving image data of the camera 311 is in a state where it is supplied to the image processing apparatus 201 but is not selected (this state is referred to as standby). Meanwhile, the camera 312 is in the sleep state. Therefore, moving image data is not supplied from the camera 312 to the image processing apparatus 201. In this case, the image processing apparatus 201 alternately selects moving image data supplied from the camera 300 and moving image data supplied from the camera 311, and outputs the selected moving image data to the distribution system 210.

Note that in the present specification, a selection of moving image data supplied from the camera 300 as an output to the distribution system may be expressed as a selection of the camera 300. The same goes for the cameras 311 and 312.

In the example shown in FIG. 7, a weight (sensitivity) is set for each of the cameras and for each of the four types of evaluation values. It is assumed here that an integer from 0 to 10 can be set as a weight, with 10 being the largest weight. The timer computation unit 202C does not take an evaluation value with a weight of 0 into account. The magnitude of the weight can be reflected in at least one of the magnitude of a threshold applied to an amount of change and the magnitude of a unit of increase/reduction in a count value.

For example, regarding an amount of change in the volume, it is assumed that a threshold for a case where a reference weight (e.g., 5) has been set is 5 db, and the count value is increased/reduced when an absolute value of an amount of change in the volume is equal to or larger than the threshold. The unit of increase/reduction may be constant. In this case, the timer computation unit 202C makes the threshold smaller than 5 db (e.g., 2 db) in a case where a weight larger than the reference (e.g., 10) has been set, and makes the threshold larger than 5 db (e.g., 10 db) in a case where a weight smaller than the reference (e.g., 1) has been set. In this way, with regard to an evaluation value with a large weight, the count value is easily increased/reduced in response to a change in the evaluation value, whereas with regard to an evaluation value with a small weight, the count value is not easily increased/reduced in response to a change in the evaluation value. That is to say, the sensitivity of the increase/reduction in the count value in response to a change in an evaluation value can be controlled in accordance with the magnitude of the weight of the evaluation value.

Furthermore, in a case where a weight is reflected in the unit of increase/reduction in the count value, with respect to the unit of increase/reduction for a case where a reference weight of 5 has been set, the timer computation unit 202C can reduce the unit of increase/reduction to ½ in the case of a weight of 1, and double the unit of increase/reduction in the case of a weight of 10. It should be noted that the reference weight and the specific method of reflecting weights are merely examples.

The timer computation unit 202C determines a final adjustment amount on the basis of, for example, adjustment amounts of the count value or the initial value that have been calculated for the respective evaluation values. For example, the timer computation unit 202C can determine a sum of the adjustment amounts as a final adjustment amount in a case where the weights are reflected in the thresholds of the evaluation values, and an average value or a median value of the adjustment amounts as a final adjustment amount in a case where the weights are reflected in the unit of increase/reduction in the count value.

FIG. 8 is a diagram showing examples of setting values of the timers 600, 611, and 612 managed by the timer computation unit 202C. The timer computation unit 202C manages the timers on a per-camera basis. Also, with regard to the count value or the measured period of each timer, a range (an upper limit value and a lower limit value), the minimum period required for selection, and a reference initial value are settable. Although FIG. 8 shows a case where the setting values are periods, they may be count values. Furthermore, the lower limit value and the upper limit value of the measured period are denoted by the minimum distribution period and the maximum distribution period, respectively. In addition, the minimum period required for selection is denoted by “skip”. Values other than the reference initial value may not be set.

The reference initial value is a reference value for an initial value that is set when the timers have been initialized. For example, in the example shown in FIG. 8, the reference initial value of the timer 600 of the camera 300 is 50 seconds (or a count value for measuring 50 seconds). Also, the reference initial value of the timer 611 of the camera 311 is 2 minutes (or a count value for measuring 2 minutes).

The reference initial values shown in FIG. 8 can change depending on an adjustment made by the timer computation unit 202C before they are set as initial values of the timers. For example, the reference initial value of the timer corresponding to the camera on standby (in the example of FIG. 8, the timer 611 corresponding to the camera 311) is increased or reduced in accordance with the amounts of changes in the evaluation values while moving image data of the camera 300 is selected. Then, once the moving image data selected by the image processing apparatus 201 has been switched from the moving image data of the camera 300 to the moving image data of the camera 311, the value at that point is set on the timer 611 as the initial value, and the operation of the timer 611 begins. In the following description, when simply using the term “initial value”, it denotes a value that is held as the initial value of the timer at that point, and it can refer to both a case where the initial value is equal to the reference initial value and a case where the initial value is not equal to the reference initial value.

The minimum distribution period is equivalent to the lower limit value of the length of the selection period. With respect to moving image data from the cameras corresponding to the timers on which the maximum distribution period has been set, the control unit 202 performs control so that the selection period does not fall below the minimum distribution period. Specifically, the control unit 202 can control the adjustment made by the timer computation unit 202C on the initial value so that the initial value does not fall below the minimum distribution period during standby. Furthermore, after the selection has been made, the control unit 202 can control the adjustment made by the timer computation unit 202C on the count value so that the selection period does not fall below the minimum distribution period.

The maximum distribution period is equivalent to the upper limit value of the length of the selection period. With respect to moving image data from the cameras corresponding to the timers on which the minimum distribution period has been set, the control unit 202 performs control so that the selection period does not exceed the maximum distribution period. Specifically, the control unit 202 can control the adjustment made by the timer computation unit 202C on the initial value so that the initial value does not exceed the maximum distribution period during standby. Furthermore, after the selection has been made, the control unit 202 can control the adjustment made by the timer computation unit 202C on the count value so that the selection period does not exceed the maximum distribution period.

“Skip” indicates a lower limit value of an initial value necessary for the selection. When the control unit 202 has selected a certain camera, in a case where the initial value set on the corresponding timer is equal to or smaller than the setting value of “skip” (skip value), the control unit 202 skips the selection of moving image data from that camera. In the example of FIG. 8, assume a case where moving image data to be distributed is going to be switched from moving image data of the camera 311 to moving image data of the camera 300. In this case, if the initial value set on the timer 600 corresponding to the camera 300 to be selected next is equal to or smaller than 5 seconds, the control unit 202 skips distribution of the moving image data of the camera 300. Also, the control unit 202 initializes the timer 600 to the reference initial value (50 seconds). In the example of FIG. 8, as the camera 312 is in the sleep state, the control unit 202 continuously selects the moving image data from the camera 311. In this case, the control unit 202 may reset the distribution period of the moving image data from the camera 311 to 0, or may not reset the distribution period to 0 if the maximum distribution period has not elapsed. Note that in a case where the selected camera is to be switched due to the elapse of the maximum distribution period, if the selected camera does not change after skipping the selection of a switch-destination camera, the skip may be disabled. In a case where the minimum distribution period has been set, the skip value is set to be smaller than the minimum distribution period.

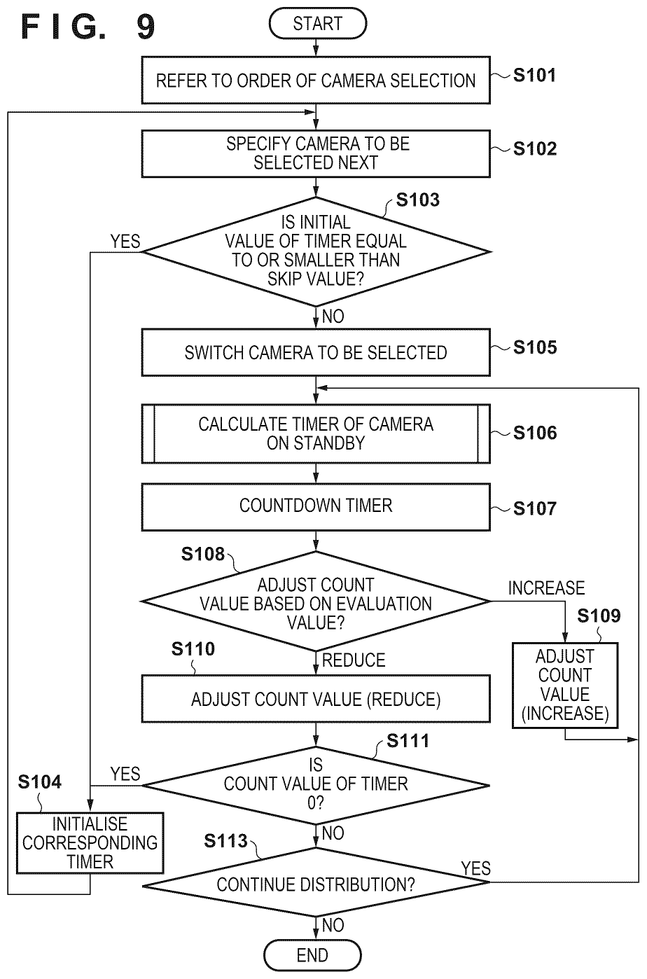

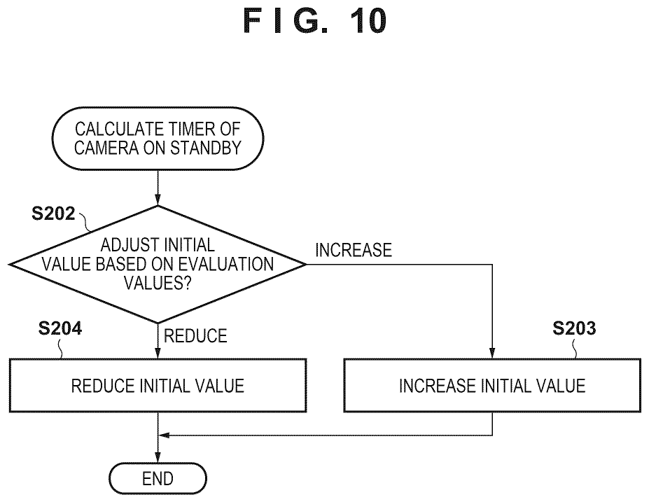

Next, the operations of the image processing apparatus 201 will be described using flowcharts shown in FIG. 9 and FIG. 10. The operations described below are executed by the control unit 202 reading the program stored in the nonvolatile memory 205 to the system memory 206 and executing the program. Note that in the following description, it is assumed that the image processing apparatus 201 is operating in the environment shown in FIG. 1 and FIG. 2.

In step S101, the control unit 202 (rotation arrangement unit 202B) refers to the order of camera selection, which is stored in the nonvolatile memory 205 in advance. It is assumed here that this order is pursuant to the above-described source rotation. Also, the order may be changeable by the user.

In step S102, the control unit 202 specifies a camera that is to supply moving image data to be distributed in accordance with the order referred to.

In step S103, the control unit 202 determines whether the initial value set on the timer corresponding to the camera specified in step S102 is equal to or smaller than the skip value with reference to, for example, the system memory 206. The control unit 202 executes step S104 if it is determined that the initial value is equal to or smaller than the skip value, and executes step S105 if it is not thus determined. Note that in a case where the skip value is not set on the timer, the control unit 202 executes step S105.

In step S104, the control unit 202 initializes the initial value of the timer corresponding to the camera specified in step S102 using the reference initial value (FIG. 8). Thereafter, the control unit 202 executes step S102.

In step S105, the control unit 202 selects moving image data supplied from the camera specified in step S102 as moving image data to be output to the distribution system 210. Also, the control unit 202 starts to measure a selection period using the system timer 208. For the second time onward, in step S105, the moving image data to be output to the distribution system 210 (the camera that supplies the same) is switched.

At a time point when step S105 has been executed for the first time, the control unit 202 starts to apply the processing for output to the distribution system 210, which has been described using FIG. 4, to the moving image data to be distributed. Also, the video analysis unit 202D starts to calculate evaluation values with respect to the moving image data to be distributed and moving image data supplied from an unselected camera that is not in the sleep state.

In step S106, based on the evaluation values calculated by the video analysis unit 202D with respect to the moving image data supplied from the camera on standby, the control unit 202 adjusts the initial value of the timer corresponding to the camera on standby. The details of the operation in step S106 will be described later.

In step S107, based on the system timer 208, the control unit 202 (timer computation unit 202C) performs a countdown from the count value of the timer corresponding to the camera currently selected. Step S107 is an operation of measuring a unit period, and the specifics of the operation, such as a countdown and a count-up, can vary depending on the type of the timer.

In step S108, the control unit 202 (timer computation unit 202C) determines the amount of adjustment of the count value of the timer corresponding to the camera currently selected on the basis of the evaluation values calculated by the video analysis unit 202D with respect to the moving image data supplied from the camera currently selected (i.e., currently distributed). The control unit 202 executes step S109 if the determined adjustment amount is an amount corresponding to an increase, and step S110 if the determined adjustment amount is an amount corresponding to a reduction.

In step S109, the control unit 202 (timer computation unit 202C) increases the count value of the timer corresponding to the camera currently selected by the adjustment amount. Thereafter, the control unit 202 executes step S106.

In step S110, the control unit 202 (timer computation unit 202C) reduces the count value of the timer corresponding to the camera currently selected by the adjustment amount. Thereafter, the control unit 202 executes step S111.

In step S111, the control unit 202 determines whether the count value of the timer corresponding to the camera currently selected has reached 0, and executes S104 if it is determined that the count value has reached 0, and step S113 if it is not thus determined.

Note that in a case where the minimum distribution period is set on the timer corresponding to the camera currently selected, the control unit 202 determines whether the selection period is equal to or longer than the minimum distribution period before executing step S104. Then, the control unit 202 executes step S104 if it is determined that the selection period is equal to or longer than the minimum distribution period, and step S106 if it is not thus determined. This can prevent the selection period from falling below the minimum distribution period.

Also, in a case where the maximum distribution period is set on the timer corresponding to the camera currently selected, the control unit 202 determines whether the selection period has reached the maximum distribution period after executing step S109. Then, the control unit 202 executes step S104 if it is determined that the selection period has reached the maximum distribution period, and step S106 if it is not thus determined. This can prevent the selection period from exceeding the maximum distribution period.

In step S113, the control unit 202 determines whether to continue the distribution of moving image data; it executes step S106 if it is determined that the distribution is to be continued, and ends outputting of moving image data to the distribution system 210 if it is not thus determined. For example, the control unit 202 can determine that the distribution of moving image data is to be continued if the user has not issued an instruction for ending the distribution via the operation unit 203.

FIG. 10 is a flowchart related to the operation of step S106 to adjust the initial value of the timer corresponding to the camera on standby.

Step S202 is an operation similar to step S108. That is to say, the control unit 202 (timer computation unit 202C) determines the amount of adjustment of the initial value of the timer corresponding to the camera on standby on the basis of the evaluation values calculated by the video analysis unit 202D with respect to the moving image data supplied from the camera on standby. The control unit 202 executes step S203 if the determined adjustment amount is an amount corresponding to an increase, and step S204 if the determined adjustment amount is an amount corresponding to a reduction.

In step S203, the control unit 202 (timer computation unit 202C) increases the initial value of the timer corresponding to the camera on standby by the adjustment amount. Thereafter, the control unit 202 executes step S107.

In step S204, the control unit 202 (timer computation unit 202C) reduces the initial value of the timer corresponding to the camera on standby by the adjustment amount. Thereafter, the control unit 202 executes step S107.

As described above, the present embodiment can provide an image processing apparatus capable of appropriately switching among videos obtained by a plurality of image capture apparatuses set at locations that are geographically different from one another. Specifically, the timing to switch a video is delayed in a case where the video exhibits a change of a certain level or more, and is advanced in a case where the video does not exhibit such a change. Therefore, the image processing apparatus according to the present embodiment can suppress a decrease in the interest of viewers of distribution caused by, for example, continuous distribution of moving image data with little variety.

### Other Embodiments

In the above-described embodiment, the adjustment of the count value of the timer corresponding to the camera currently selected is based on the evaluation values for moving image data supplied from the camera currently selected. However, the adjustment of the count value of the timer corresponding to the camera currently selected may be made in consideration of the evaluation values for moving image data supplied from the camera on standby.

For example, in a case where moving image data supplied from the camera on standby exhibits a larger amount of change than moving image data supplied from the camera currently selected, a predetermined reduction amount may be applied to the amount of adjustment of the count value of the timer corresponding to the camera currently selected. In this way, in a case where moving image data supplied from the camera on standby exhibits a larger amount of change than moving image data supplied from the camera currently selected, control can be performed to facilitate a switchover to the camera on standby.

Furthermore, the amount of adjustment of the count value may take the length of the selection period into account. For example, in a case where the selection period exceeds a predetermined period, a predetermined amount of reduction may be applied to the adjustment amount. In this way, when the distribution period exceeds the predetermined period, control can be performed to facilitate a switchover to the camera on standby.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-066823, filed Apr. 17, 2024, which is hereby incorporated by reference herein in its entirety.

What is claimed is:

1. An image processing apparatus comprising:
one or more processors that execute a program stored in a memory, and thereby cause the image processing apparatus to select one of a plurality of moving image data pieces in a predetermined order and output the selected moving image data piece to an outside, wherein the plurality of moving image data pieces being obtained by a plurality of image capture apparatuses set at locations that are geographically different from one another,
wherein the one or more processors cause the image processing apparatus to dynamically change a length of a period in which the selected moving image data piece is output to the outside, based on one or more of temporal changes in the plurality of moving image data pieces and temporal changes in information related to viewing of the moving image data piece currently selected.

2. The image processing apparatus according to claim 1, wherein
the temporal changes in the plurality of moving image data pieces include one or more of a motion in entire frames of the moving image data pieces, a moving speed or acceleration of a subject inside the frames, a change in an action or a facial expression of the subject, a luminance change in an entirety of a subject region of the frames, a change in a frame rate, and a change in a volume or a main frequency of sounds.

3. The image processing apparatus according to claim 1, wherein
the temporal changes in the information related to viewing include one or more of a change in the number of viewers, a change in the number of comments in an SNS related to the moving image data piece currently selected, the number of likes and/or dislikes, and a change in a total amount of fan funding.

4. The image processing apparatus according to claim 1, wherein
the one or more processors causes the image processing apparatus to calculate an evaluation value with respect to one or more of the temporal changes in the plurality of moving image data pieces and the temporal changes in the information related to viewing of the moving image data piece currently selected, and increase the length of the period in a case where the evaluation value exceeds a threshold.

5. The image processing apparatus according to claim 1, wherein
the one or more processors causes the image processing apparatus to calculate an evaluation value with respect to one or more of the temporal changes in the plurality of moving image data pieces and the temporal changes in the information related to viewing of the moving image data piece currently selected, and reduce the length of the period in a case where the evaluation value does not exceed a threshold.

6. The image processing apparatus according to claim 4, wherein
the one or more processors causes the image processing apparatus to change the threshold or a unit of increase/reduction in the length of the period on a basis of a weight set for the evaluation value.

7. The image processing apparatus according to claim 1, wherein
the one or more processors causes the image processing apparatus, also with respect to an unselected moving image data piece among the plurality of moving image data pieces, to dynamically change the length of the period on a basis of temporal changes in the unselected moving image data piece.

8. The image processing apparatus according to claim 7, wherein
the one or more processors causes the image processing apparatus, when switching a selected moving image data piece in accordance with the predetermined order, if the period related to a moving image data piece to be selected next is equal to or shorter than a predetermined length, to skip a selection of the moving image data piece to be selected next.

9. The image processing apparatus according to claim 7, wherein
the one or more processors causes the image processing apparatus to dynamically change the length of the period so that the length of the period related to the unselected moving image data piece does not fall below a predetermined length.

10. The image processing apparatus according to claim 1, wherein
the one or more processors causes the image processing apparatus, in a case where a length of a period in which the moving image data piece currently selected has been selected has reached a predetermined length, to switch selected moving images even if the period of the dynamically-changed length has not elapsed.

11. The image processing apparatus according to claim 1, wherein
the one or more processors causes the image processing apparatus to reduce the period in a case where a length of a period in which the moving image data piece currently selected has been selected has exceeded a predetermined length.

12. An image processing method comprising:
selecting one of a plurality of moving image data pieces in a predetermined order and outputs the selected moving image data piece to an outside, wherein the plurality of moving image data pieces being obtained by a plurality of image capture apparatuses set at locations that are geographically different from one another;
based on one or more of temporal changes in the plurality of moving image data pieces and temporal changes in information related to viewing of the moving image data piece currently selected, dynamically changing a length of a period in which the selected moving image data piece is output to the outside.

13. A non-transitory computer-readable medium storing a program for causing a computer to function as an image processing apparatus that selects one of a plurality of moving image data pieces in a predetermined order and outputs the selected moving image data piece to an outside, wherein the plurality of moving image data pieces being obtained by a plurality of image capture apparatuses set at locations that are geographically different from one another,
wherein the image processing apparatus dynamically changes a length of a period in which the selected moving image data piece is output to the outside, based on one or more of temporal changes in the plurality of moving image data pieces and temporal changes in information related to viewing of the moving image data piece currently selected.
